(19) United States
(12) Patent Application Publication
(10) Pub. No.: US 2007/0107523 A1
(43) Pub. Date: May 17, 2007

(54) Distributed Pressure Sensoring System

(76) Inventor: Carl Johan Galewski, Santa Cruz, CA (US)

Correspondence Address: CENTRAL COAST PATENT AGENCY, INC, 3 HANGAR WAY SUITE D, WATSONVILLE, CA, 95076, US

(21) Appl. No.: 11/554,441

(22) Filed: Oct. 30, 2006

Related U.S. Application Data
(60) Provisional application No. 60/732,244, filed on Oct. 31, 2005.

(51) Int. Cl. G01L 9/00

(52) U.S. Cl. 73/754

(57) ABSTRACT

A system is provided for sensing and monitoring pressure conditions and variations over an actual or represented surface area of a workpiece in a process chamber. The system includes a substrate and a plurality of micro-electrical-mechanical-systems (MEMS) pressure sensors fixed to the substrate.

### CROSS-REFERENCE TO RELATED APPLICATIONS

The present invention claims priority to a U.S. provisional patent application Ser. No. 60/732,244 entitled “Pressure Distribution Monitor” filed on Oct. 31, 2005. The referenced application is included herein at least by reference.

### BACKGROUND OF THE INVENTION

1. Field of the Invention

The present invention is in the field of gas phase processing, and pertains particularly to methods and apparatus for measuring local pressure values inside process chambers.

2. Discussion of the State of the Art

The technique of gas phase processing is commonly used in large-scale manufacturing to deposit or remove layers from workpieces. The technique typically involves exposing a workpiece to a gaseous ambient of controlled composition and pressure in a process chamber with the addition of some form of energy such as temperature or radio frequency (RF) to induce a reaction to occur between the gaseous ambient and the workpiece. For example, the manufacture of integrated circuits, flat panel displays, and machine tools with wear resistant coatings are all accomplished with the aid of gas phase processing as described above.

To ensure predictable results it is important to adequately control the conditions inside the process chamber when gaseous processing is carried out. The concentration of gas species, temperature, and pressure are examples of fundamental parameters that determine the results of a gaseous process. Therefore, many methods and tools to measure the conditions inside processing chambers have been developed. A few examples of such methods are the optical emission spectrum measured at a view port of a plasma reactor, voltage from a thermocouple embedded in a heater, and signal from a pressure gauge connected to a port on the processing chamber. Commonly used measurement techniques, as in the case of the above examples, typically only provide a value representative of an average, or inferred value of the local conditions at the workpiece surface.

To keep up with the manufacturing requirements for more precise processes, higher rates, and larger workpieces the control and uniformity of gaseous processing is increasingly important. For example, in semiconductor processing feature sizes are constantly shrinking while wafer sizes are increasing. Currently the feature size is approaching 65 nm on a wafer size of 300 mm diameter with plans in place to continue shrinking feature size and increase wafer size to 450 mm diameter. The manufacturing of liquid crystal displays (LCD) area has seen the substrate size double every 1.5 years and now is approaching 2.2 by 2.5 m in size.

In a typical gas phase process there is a flow of gas maintained through the reactor chamber in order to replenish reactants and remove reaction byproducts. Since the flow rate of a gas is directly related to a decrease in pressure in the flow direction pressure inside a processing chamber operating at reduced or elevated pressure may very considerably from point to point inside the chamber. These local pressure variations are linked to gas flow and concentration that influence the process results at those same points. It is, therefore, desired that the conditions that a workpiece are subjected to inside a process chamber may be accurately established, monitored and controlled. This is particularly important for ability to verify correct operation and also to calibrate any indirect measuring instruments.

Devices for gauging temperature and pressure inside a process chamber are common. However, those gauges are most-often mounted externally to the process chamber and may only measure conditions near a workpiece. These devices typically cannot measure pressure, for example, at specific surface point locations or small areas of a workpiece surface. The inventor is aware of a thermocouple-instrumented workpiece for calibrating process chamber temperature profiles and for temperature control related to semiconductor manufacturing tools. Gauges for measuring pressure are mostly externally mounted and exhibit limitations in measuring the small and/or rapid changes in pressure that can occur inside the chamber that might have a significant impact on the manufacturing results obtained in process chambers. For example, the inventor has direct experience that pressure bursts of a few tore in the 100 ms range (faster than could be measured conventionally) can significantly affect particulate formation and performance results in semiconductor manufacturing equipment.

What is clearly needed is a system and apparatus for detecting pressure conditions and variations across a workpiece surface inside a processing chamber. A method and apparatus such as this would enable real time pressure sensing across representative areas of a workpiece for purpose of verifying operation process chambers, enhance process control, improving reaction uniformity, and reduce the number of particles transferred to workpieces.

### SUMMARY OF THE INENTION

A system is provided for sensing and monitoring pressure conditions and variations over an actual or represented surface area of a workpiece in a process chamber. The system includes a substrate, and a plurality of micro-electrical-mechanical-systems (MEMS) pressure sensors fixed to the substrate. In one embodiment, the substrate is a dummy testing wafer. In one embodiment, the substrate is an actual workpiece wafer.

In one embodiment, the process chamber is a vacuum assisted atomic layer deposition chamber. In one embodiment, the pressure sensors are capacitance pressure sensors. In another embodiment, the pressure sensors are piezoresistive pressure sensors. in one embodiment, the pressure sensors include leads for power and return. In another embodiment, the pressure sensors include wireless transmission capability.

In one embodiment, the system further includes a monitoring station coupled to the sensors by wiring. In another embodiment where the sensors include wireless transmission capability, the monitoring station the system further includes a monitoring station coupled to the sensors by a wireless network. In yet another embodiment, the pressure sensors are mechanical cantilevers. In this embodiment, using mechanical cantilevers, the system further includes one or more optical laser scanning heads, and a monitoring station coupled to the scanning heads.

In one embodiment, the pressure sensors contain memory for storing permanent data and for storing pressure readings. In a variation of this embodiment, the memory is flash-based. In a further variation to this embodiment, the memory is magnetic flash memory. In this embodiment, the system further includes a magnetic reader for accessing and erasing the magnetic flash memory.

According to another aspect of the invention, a method for recording pressure variations across a representative or actual surface of a substrate under vacuum is provided. The method includes the acts (a) staging a substrate having multiple MEMS pressure sensors fixed thereto in the vessel subject to vacuum; (b) connecting the substrate to an external monitoring station; (c) pumping down the vessel; (d) activating the sensors; (e) recording the multiple pressure readings; and (f) calculating the pressure variations from the multiple readings.

In one aspect of the method, in act (a), the substrate is a dummy test wafer. In another aspect, in act (a), the substrate is an actual workpiece wafer. In one aspect of the method, in act (b), the connection is a wired connection. In another aspect, in act (b), the connection is a wireless connection.

In one aspect of the method, wherein in act (d), the sensors are powered from outside the vessel by wire. In another aspect, in act (d), the sensors are powered from a battery cell mounted on the substrate. In another aspect of the method, in act (b), monitoring is performed externally to the process system using pressure values stored in local memory and thus the complete pressure history from loading to exit from the tool can be recorded.

According to yet another embodiment of the system, sensors for detecting temperature or gas species, or combination of those are included on or near the pressure sensors. In this embodiment, readings from the temperature sensors or gas sensors of from a combination of those are used as variables for calculating local flow rates or gas concentrations.

### BRIEF DESCRIPTION OF THE DRAWING FIGURES

FIG. 1 is an elevation view of a deposition chamber and pressure sensing system according to an embodiment of the present invention.

FIG. 2 is an overhead view of the pressure sensing system of FIG. 1.

FIG. 3 is an overhead view of a pressure sensing system according to another embodiment of the present invention.

FIG. 4 is an elevation view of a deposition chamber with a pressure sensing system according to another embodiment of the present invention.

FIG. 5 is a block diagram of an individual sensor used in one embodiment of the present invention.

FIG. 6 is a block diagram illustrating an individual sensor used in another embodiment of the present invention.

FIG. 7 is a block diagram illustrating an individual sensor used in another embodiment of the present invention.

FIG. 8 is a block diagram illustrating an individual sensor used in another embodiment of the present invention.

### DETAILED DESCRIPTION

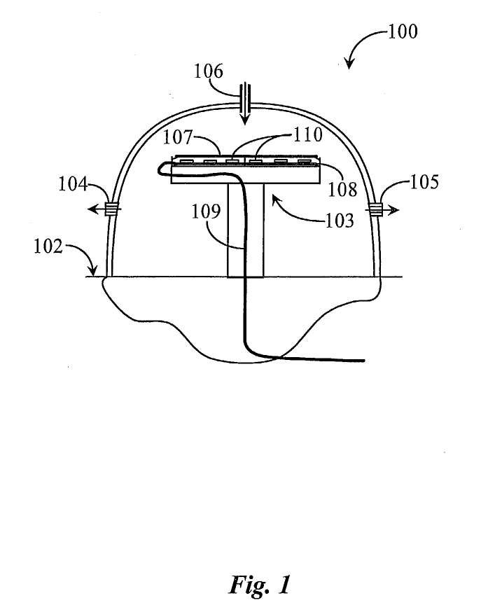

FIG. 1 is an elevation view of a process chamber 100 and pressure sensing system 108 according to an embodiment of the present invention. Chamber 100 is exemplary only and is intended here to represent generically a process chamber for implementing a gas phase process, which may be an atomic layer deposition (ALD) process in one example. Chamber 100 may be manufactured of aluminum, stainless steel, or other suitable materials for the type of process being considered. Materials acceptable in vacuum processing may include graphite, quartz glass, ceramic, and others. One important characteristic relative to the present invention is that gas pressure inside the chamber is an important variable to success in the particular process conducted within the chamber. Local pressure is typically an important variable related to both the flow and rate at that point. This importance dictates the exact deposition processes that the invention applies to, one of which may be ALD. It is important to note herein while ALD is used as an example in this specification, other gas phase processes where pressure variances inside the chamber affect processing may also benefit from the present invention.

Chamber 100 includes a hearth 103 as an illustrative method for supporting a workpiece 107 for processing. Workpiece 107 may be a semiconductor wafer, for example, or a glass substrate for a flat panel display, or some other type of product requiring gas phase processing. In this example, workpiece 107 is a semiconductor wafer and the desired gas phase process is thin film deposition at sub-atmospheric pressure for discussion purposes and because of design convenience in implementing the invention in a deposition process.

Chamber 100 has a gas introduction valve 106 adapted for introducing dose gasses and purge gasses into the chamber over workpiece 107. There maybe more introduction valves in chamber 100 that is illustrated here, however the illustration of just one valve is deemed sufficient for explaining the invention. Chamber 100 has a vacuum assisted pump-out valve 104 and a vacuum assisted pump-out valve 105 for creating high flows under vacuum for purging reactive gasses from the area of workpiece 107 as is typical in ALD processing. In actual practice, there may only be one such valve or several depending on the design and process. The valves may also be configured so that gas flows across the workpiece in a parallel fashion.

A vacuum plane 102 is logically illustrated in this example to represent the vacuum ability of chamber 100 that it may be pumped down to vacuum pressures and released from vacuum pressure in a controlled manner. One characteristic that is important to processing in this embodiment is that the pressure inside the chamber under vacuum can be detected and monitored for subtle changes relative to areas important to processing such as at the surface of workpiece 107. Typical pressure sensors are mounted externally via a small port to measure general pressure inside the chamber and do not provide multiple granularly scalable readings across a workpiece surface. In addition external sensors are often limited in their response time by the conductance in the sampling port.

Therefore, a pressure measuring system 108 is provided that contains multiple pressure sensor devices 110. Pressure measuring system 108 is provided in the form of a silicon wafer having attached or otherwise manufactured thereon multiple pressure sensors 110. Pressure sensors 110 may, in one embodiment, be MEMS pressure sensors that are known to and available to the inventor for measuring pressure by difference in capacitance measured. In another embodiment, pressure sensors 110 may be resistive sensors employing Piezoresistive physics where the measure is resistance variation. There are also Resonance pressure sensors where the measure is frequency shift and Piezoelectric pressure sensors where the measure is frequency shift and the output is an electrical signal. There are also sensors known to the inventor for temperature and gas species that can be incorporated on the MEMS sensor chip or nearby. Temperature sensors include thermocouples that measure voltage of a junction of two dissimilar metals. Gas species sensors include micro machined beams with a molecule specific adsorptive coating that deflects when gas molecules are adsorbed.

In this example, a number of MEMS sensors 110 are installed on or otherwise fabricated directly on a silicon wafer using semiconductor manufacturing techniques such that system 108 takes the form of a “dummy” testing device or system of multiple sensors wherein the sensors are strategically located to detect proximal gas pressure conditions that would occur at the same locations on near the surface of an actual workpiece such as workpiece 107 of the same or very similar wafer size.

In this example, system 108 is staged in the process chamber with workpiece 107 and may monitor pressure variations locally with respect to each individual pressure sensor, in this case proximal to (directly beneath) the same locations on workpiece 107. System 108 may be customized for a specific deposition chemistry through pretreatment in a separate deposition process with any material that a chemistry used in deposition does not adhere to so that the system does not become coated and is reusable.

In one embodiment, system 108 is used in the absence of an actual workpiece to gauge process pressure conditions and gradients and to calibrate the system for optimum processing on an actual workpiece. In this embodiment, system 108 would be removed from the chamber before processing an actual wafer. Also in this embodiment, system 108 may be staged in the exact location as the actual workpiece 107. In this embodiment it is also possible to add sensors for temperature and gas phase species as described previously.

In this particular embodiment, each sensor 108 has a voltage line and a return line. These traces can be provided from the individual sensors through the silicon to an edge of the wafer so that they may harnessed into a single wire 109 that may be fed through hearth apparatus 103 and out of the chamber through the bottom of the chamber. An external monitoring system may be used to monitor the pressures and to suggest adjustments to the deposition equipment to improve the processing under those conditions. Steps may also be taken to adjust internal pressures if sensors report readings outside of an acceptable range.

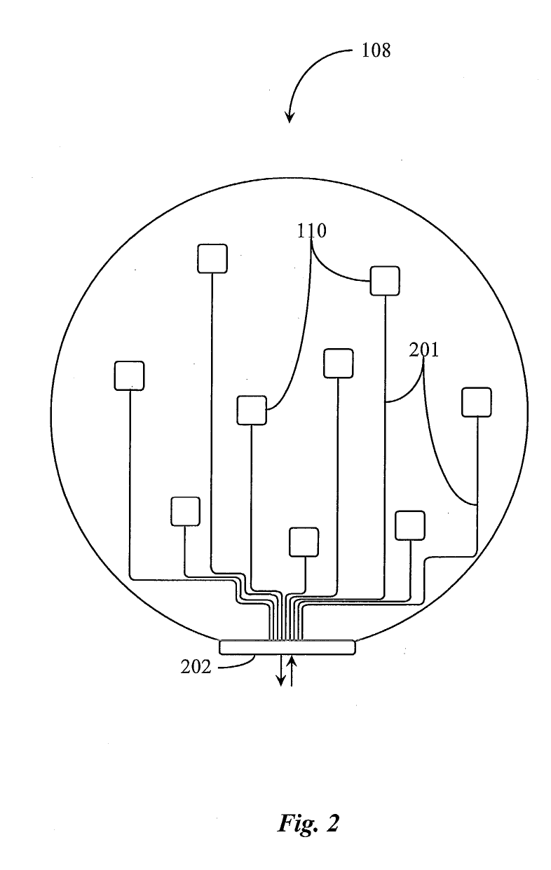

FIG. 2 is an overhead view of the pressure sensing system of FIG. 1. System 108 is in the form of a “dummy” test wafer in this example. Pressure sensors 110 are illustrated in various locations about the surface of the dummy wafer. The exact number of sensors employed and the exact pattern of arrangement of those sensors over the surface of the wafer is a matter of design consideration. No particular pattern of importance is represented in this example. It is feasible that the entire footprint of the dummy wafer is covered with individual sensors 110. In another embodiment, there may be fewer sensors deployed than the number shown.

In this example, each sensor 110 has a logical trace 201 connected to the sensor and leading to an electrical interface 202 where the individual traces are harnessed to form a single bus or cable leading out of the chamber to a monitoring station (not shown). Each trace 201 may be assumed to provide the voltage required to power each sensor and the return line for reading the difference in capacitance indicative of the current pressure reading at any given point in time. System 108 may be manufactured using semiconductor processes leaving the wafer complete with installed and routed sensors. In another embodiment, individual sensors may be acquired and then mounted on a blank wafer using semiconductor manufacturing techniques. For example, the sensors may be mounted and connected by wire bonding or other well established techniques used in IC chip packaging. One advantage of using MEMS pressure sensors like sensors 110 is that the pressure-sensing member can be very light so as to respond to rapid changes in pressure in the millisecond range, or better. The small size of the MEMS sensor enables, as described, multiple sensors to be attached to the testing device to determine pressure variations relative to any point on a surface of a workpiece. The advantage of using traces on the substrate to connect the sensors is avoiding disturbing the gas flow and hence may affect the pressure readings.

In one embodiment, sensors 110 may be provided and attached to actual work pieces like workpiece 107 of FIG. 1. Li this embodiment, the sensors may be attached to a blank wafer that will be processed in the chamber. An advantage to this approach is that pressure readings may be taken while actual wafer processing is occurring in the chamber. One possible drawback to this embodiment is that the footprints of the sensors on an actual workpiece represent scrap space on that workpiece and may result in lower yield of usable devices. In this embodiment one may also need to incorporate some form of shielding to protect the sensor from coating or etching by the gas phase process investigated. For a deposition process it is possible to include a coating on the MEMS sensor that prevents deposition. It is also possible to employ a shielding layer with small holes that prevent depositing gas species from reaching the pressure sensing member.

In another embodiment where each sensor is powered and monitored externally from the chamber, loose wiring may be provided to each sensor instead of manufacturing traces in the silicon wafer substrate for each sensor.

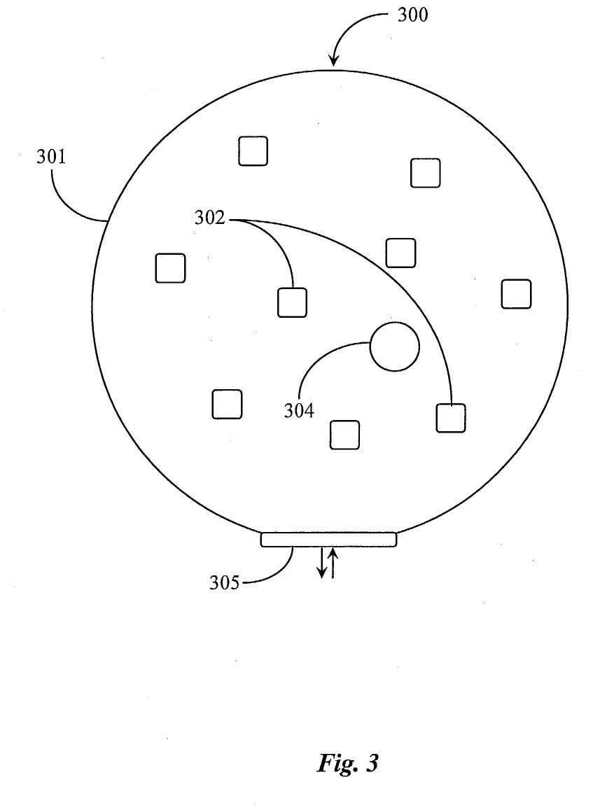

FIG. 3 is an overhead view of a pressure sensing system 300 according to another embodiment of the present invention. Pressure sensing system 300, like system 108 previously described takes the form of a silicon wafer 301, optimally the same diameter as an actual workpiece wafer. System 300 has multiple pressure sensors 302 provided thereon in a manner very similar to that previously described above. Sensors 302 maybe MEMS sensors adapted to communicate values via some wireless communication protocol such as, but not limited to RF, infrared, or other wireless protocols. In this example, wafer 301 has a power source 304 provided thereto by semiconductor manufacture or external mounting. Power source 304 may be a battery cell that is adapted via individual traces (not illustrated) to provide the required voltage to run each pressure sensor 302. Power source 304 may also be an antenna that allows the RF signal used to communicate with the sensors to also provide power for their operation similar to the technology used for RFID tags.

Wafer 301 has a wireless communication hub or router 305 mounted at the peripheral edge of the system. Hub 305 is also powered by power source 304 and can communicate wirelessly to each of the individual sensors 302. In this embodiment, each sensor may be adapted with a micro receive/transmit (RX/TX) circuit and a memory circuit to hold a sensor ID number for network identification, one or more state machines indicating status, and one or more measured values indicative of pressure readings taken that can be communicated wirelessly through hub 305 and to an outside monitoring station. In this case, there are no wires that need to be routed through the chamber or other components. The monitoring station may keep track of each sensor online and may access any readings taken by each sensor at any time. One aspect of this embodiment is that MEMS sensors are slightly more complicated having added RX/TX ability and a memory for retaining machine identification on a network and to store values. Therefore, these pressure sensors may be more expensive to provide, even in batch operations.

In one embodiment, any cost additions may be offset by capability of accessing the information wirelessly without opening the chamber and the ability to access sets of subsequent values representing pressure readings from an individual sensor rather than just one value at a time. Also, wireless sensors may be activated or disabled at will leaving open an opportunity for selective groups of sensors deployed over the substrate to be activated at selected points in time. Also, it is possible with a variation of this embodiment to have the wafer store all the measured values to be read out once the wafer is removed from the complete processing system that may include transfer chambers and load-locks. Advantage in this variation of the embodiment is that one can investigate the full history of the wafer in the processing system. For example, poor pressure control in load-locks can generate gas phase particles that transfer to the wafer.

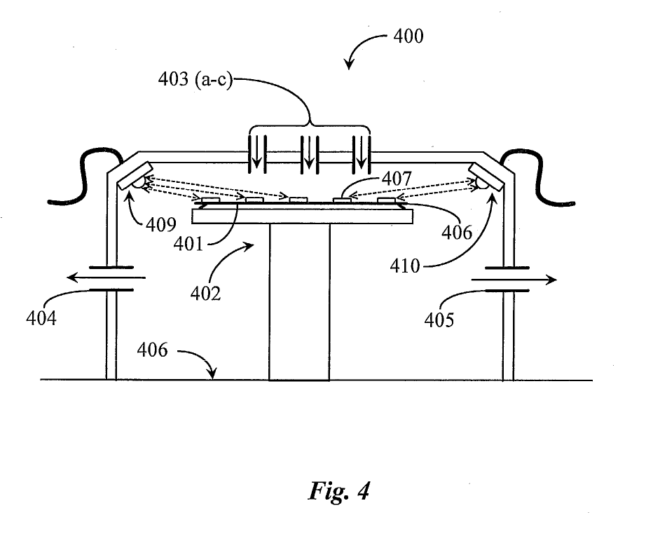

FIG. 4 is an elevation view of a deposition chamber 400 with a pressure sensing system 406 according to another embodiment of the present invention. Chamber 400 is exemplary only and is intended to represent a process chamber that is part of a gas phase deposition system, which may include ALD. Chamber 400 may be constructed of like materials described with respect to chamber 100 of FIG. 1. Chamber 400 includes a hearth 402 for supporting a workpiece 401, which is of the form of a semiconductor wafer in this example.

Chamber 400 includes three gas introduction valves illustrated herein as valves 403(a-c) and two vacuum pump-out valves illustrated herein as pump-out valves 404 and 405. Introduced gasses including purge gasses may enter into chamber 400 through valves 403(a-c) according to the direction of the arrows. Likewise, reactants may be pumped out through valves 404 and 405 along the direction of the arrows.

In this example, workpiece 401 is also adapted as an area pressure sensing system. In this case, multiple pressure sensors 407 are provided on wafer 401 by way of semiconductor manufacture as a pre-process to the deposition process. In this example a power source is not required to practice the invention as will be described further below.

Sensors 407, in one embodiment, are MEMS pressure sensors that contain very small cantilevers situated over a reflective surface in a manner that pressure incurred displaces the cantilever from its normal position. In this case, the pressure measurement at any given point in time is the measurement of the displacement of the cantilever on the sensor. The measurement may be quantified and equated by calibration techniques to the amount of pressure working on the sensor. The measurement may, in this case be observed by scanner heads 409 and 410 strategically located within chamber 400. For example, sensors 407 may be strategically located on wafer 401 in a known and repeatable pattern. Each scanner head 409 and 410 can emit multiple laser light beams focused on those cantilevers with pinpoint accuracy. By emitting light and measuring the reflection of that light off of the reflective material, the scanner head can read the deflection amount in the position of the cantilever. In this embodiment, no electronic circuitry is required in the MEMS device. Only the semiconductor materials used to create the cantilevers and reflective surfaces are required. Measures may be provided to protect the cantilevers from deposits by housing them beneath a transparent surface treated with a translucent material that the deposition chemistry does not adhere to.

In this example, there are two illustrated scanner heads. However, there may be more than two scanner heads provided without departing from the spirit and scope of the present invention. The heads may be mounted to the inside of chamber 400 with vacuum seals for the openings through which cables are routed to the external monitoring system. hi still another embodiment, MEMS pressure sensors 407 may include a micro display surface for displaying a particular pressure value measurement such as by light emission along a graduated scale/mask pattern representing a graduated pressure range.

In this embodiment, the MEMS sensors may be powered circuits such as the known MEMS pressure sensors mentioned further above. In this case, sensors 407 may utilize an onboard power source attached to the substrate such as a battery cell similar to power cell 304 illustrated in the wireless transmission embodiment of FIG. 3. Additional circuitry could be added to power one of several micro light sources arrayed along the scale such as a miniature light emitting diode (LED). A laser light could then detect the position of emitted light from the sensor “scale” and determine which point in the scale the light is emitting from indicating the pressure value with high resolution. Another option would be to transmit the data via modulating a light signal such as in the techniques being proposed for reducing delays of interconnects in integrated circuits. There are many possibilities for implementing an optically readable pressure sensing system.

One with skill in the art of MEMS technology will appreciate th-at reducing or eliminating requirements of individual MEMS sensors may create an economic feasibility for using those sensors as through-away sensors used only once wherein those sensors are fabricated into the actual workpieces in a pre-deposition semiconductor process. After deposition process is completed, the sensors may be discarded and the useable die may be packaged. The improvements obtained in thin film quality, particulate management, and overall yield of useable die through improved pressure monitoring capabilities may offset the loss of the accumulated footprint of those disposable sensors built into the wafer. For larger diameter wafer processing, such sacrifice may be perfectly reasonable.

In one embodiment where the substrate supporting the pressure sensors is an actual workpiece wafer, regardless of whether the pressure sensors are accessed by wire, communicate via wireless transmission, or are mechanical “cantilevered sensors”, the data accessed from those sensors in real time may be fed back to deposition control apparatus like actuated gas introduction valves and actuated vacuum pump-out valves for the purpose of adjusting dose and purge processes according to the provided sensor data. In this way, a closed loop system may be provided that automatically adjusts to achieve optimum pressure conditions, vacuum levels, and optimum dose and/or purge gas introduction amounts and pulse rates to accomplish higher quality deposition. A system such as this would first be calibrated for acceptable deposition conditions and then would fine tune itself during operation, able to adjust for slight changes in pressure conditions and gradients recorded over time.

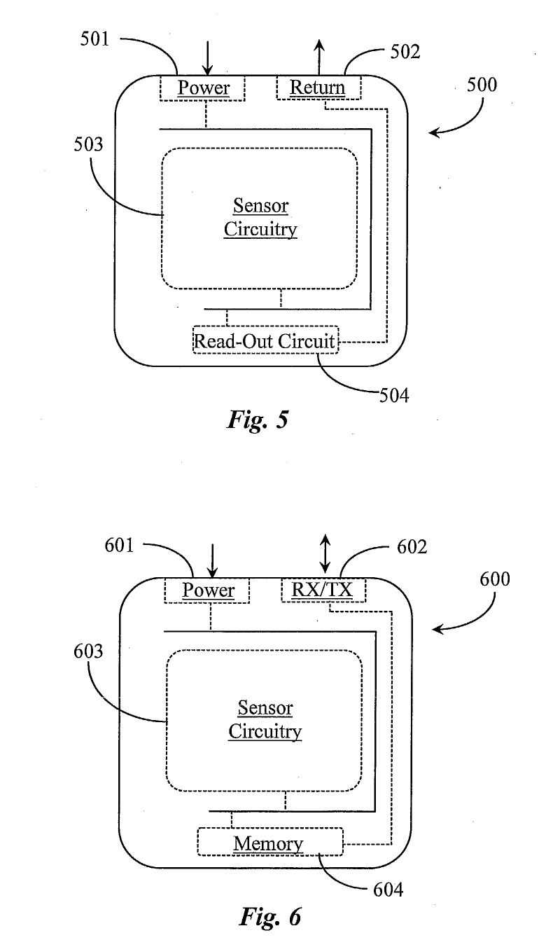

FIG. 5 is a block diagram of an individual pressure sensor 500 used in one embodiment of the present invention. Pressure sensor 500 is analogous to sensors 110 described in FIG. 1 above. Sensor 500 has a sensor circuitry 503, which may be a capacitance circuit, a Piezoresistive circuit or some other known circuit. Sensor 500 has a power line 501 and a return line 502. Sensor 500 has a simple read-out circuitry for communicating the pressure values detected back to a monitoring station through the return line. Pressure sensor 500 is a MEMS sensor and communicates by wire or trace to an external monitoring station.

FIG. 6 is a block diagram illustrating an individual pressure sensor 600 used in another embodiment of the present invention. Pressure sensor 600 is analogous to pressure sensor 302 described above with reference to the description of FIG. 3. Pressure sensor 600 has pressure sensor circuitry 603, which may be a capacitance circuit or a Piezoresistive circuit or some other known circuit capable of detecting pressure. Like sensor 500, sensor 600 includes a power line in 501 to supply voltage to the circuitry. In this example, circuit 600 has a memory circuit for storing a unique sensor identification number and, perhaps network address information for identifying the sensor and its location on a network of sensors. Memory 604 may be some form of non-volatile memory like a flash memory. There are several forms of flash memory including magnetic flash memory that may be read using a magnetic head.

Sensor 602 has an RX/TX circuitry provided for wireless communication using some wireless communication protocol. In this case, sensor 600 may receive wireless requests from a remote machine and may transmit pressure data to the requesting machine. One advantage of a MEMS pressure sensor adapted for wireless access and transmission is that it may be activated or disabled by remote command. In this way, there may be more than one pattern of sensors provided on a dummy wafer to form a pressure sensing system wherein one or the other pattern of sensors may be activated as required. For example, it may be desired only to activate sensors located toward the edges of the dummy wafer. It may be desired to activate a sparse sampling of sensors skipping sensors located in-between activated sensors. MEMS wireless pressure sensors such as sensor 600 may be selectively brought online as required during any testing sequence.

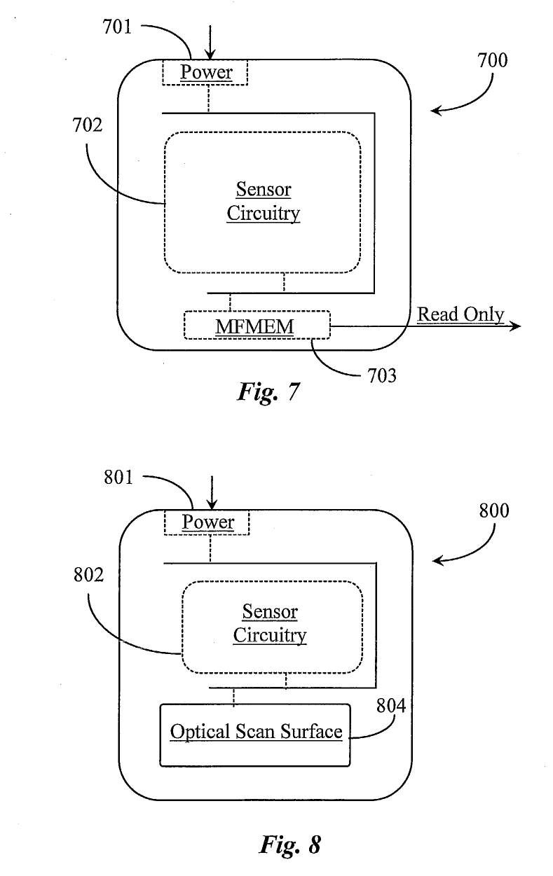

FIG. 7 is a block diagram illustrating an individual pressure sensor 700 used in another embodiment of the present invention. Sensor 700 includes pressure sensor circuitry 702 and a power in line 701. In this example, sensor 700 includes a magnetic flash memory (MFMEM) 703 that may be accessed using a magnetic reader head. In this case, there are no wires out of the sensor or RX/TX circuitry. In this embodiment, sensor 700 stores pressure readings for later access after a test cycle has been performed. For example, a dummy wafer containing multiple sensors 700 is activated during the appropriate deposition pressures and temperature conditions that would be imposed on an actual workpiece. After the sensors detect and store their respective pressure values, the wafer containing the sensors is removed and may be read using a machine like a card reader adapted with a bay or dock for docking the wafer with the pressure sensors and accessing the memories of those sensors to glean the data.

In one embodiment, powering on sensor 700 causes a pressure detection event. The value associated with that event is stored in memory. Powering off sensor 700 and then powering it on again may cause another pressure detection and value store. After a cycle, there may be more than one value stored in memory that may be read as successive events taken during the cycle. The reader may perform an erase of memory 703 to free it up for use during a next test run. Ideally, pressure conditions recorded during the test run for dosing, for example, will be substantially the same as pressure conditions that will be experienced when the actual workpiece is run given the same chamber, temperature and vacuum settings. Likewise, pressure readings during a test purge run may also provide useful information for fine-tuning the process to reduce or eliminate particle formation or undesired latent reaction of gasses.

FIG. 8 is a block diagram illustrating an individual pressure sensor 800 used in another embodiment of the present invention. Pressure sensor 800 is analogous to sensor 407 described further above with reference to the description of FIG. 4 where the sensor is powered and contains pressure sensing circuitry. Pressure sensor 800 has a power in line 801, sensor circuitry 802, which may be a capacitive circuitry, a Piezoresistive circuitry or some other known circuitry for testing pressure. Pressure sensor 800 in this example has an optical read surface 804 that may be adapted as a display panel for displaying an indication of a pressure reading that is accessible to an optical scanning system. In one embodiment, the surface may be graduated in the form of a scale by masking and etching over a transparent material like glass.

Additional circuitry might be provided such as a chain of micro LEDs linearly deployed one at each demarcation point in the scale. In this case the detected pressure value determines which LED will light on the scale provided that the value is within the calibration limits of the scale. If no light is detected then the pressure is off of the acceptable range of expected pressure variance for that sensor. One with skill in the art of MEMS will appreciate that there are different ways to provide some visible indication of voltage variance on a surface material such as exciting phosphorous materials or the like to obtain some indication of a pressure reading. Optical laser scanners like scanner heads 409 and 410 maybe mounted inside a chamber and positioned to focus on sensor display surfaces. Depending on chamber design and materials, optical reading can be performed from outside the chamber if the chamber has one or more transparent portal windows.

The importance of being able to “look” at the sensors and interpret the data according to physical deflection measure of a sensor component or by validating an illuminated position along a micro scale cannot be understated. Such a system would eliminate wiring or tracing requirements for interfacing the sensors to an external monitor. Likewise, no circuitry for wireless transmitting or memory would be required for enabling sensor data to be accessed from outside the chamber. A one-time expense for the scanning system would be minimal compared to costs of increased labor of routing multiple sensor leads or the added cost of wireless communication-capable MEMS pressure sensors.

The system of the present invention may be provided using different MEMS pressure sensor designs and communication methods as described in the various embodiments of this specification. Moreover, the system of the present invention may include the grouping of multiple sensors on a substrate, an external monitoring station able to process sensor data, and one or more communication mechanisms, including a magnetic reader, in one example, for accessing the sensor data from the sensors. The system of the invention can be implemented using “dummy wafers” having the pressure sensors attached or otherwise manufactured there on or “actual workpieces” that may have the pressure sensors attached or otherwise manufactured thereon in a pre-deposition phase of manufacturing. There are many different design variations that are possible without departing from the spirit and scope of the present invention.

In light of the embodiments described already and those that may be conceived and enabled using components described herein, the present invention should be afforded the broadest possible interpretation. The spirit and scope of the present invention is limited only by the following claims.

What is claimed is:

1. A system for sensing and monitoring pressure conditions and variations over an actual or represented surface area of a workpiece in a process chamber comprising:
a substrate; and
a plurality of micro-electrical-mechanical-systems (MEMS) pressure sensors fixed to the substrate.

2. The system of claim 1, wherein the substrate is a dummy testing wafer.

3. The system of claim 1, wherein the substrate is an actual workpiece wafer.

4. The system of claim 1, wherein the vacuum-assisted deposition chamber is an atomic layer deposition chamber.

5. The system of claim 1, wherein the pressure sensors are capacitance pressure sensors.

6. The system of claim 1, wherein the pressure sensors are piezoresistive pressure sensors.

7. The system of claim 1, wherein the pressure sensors include leads for power and return.

8. The system of claim 1, wherein the pressure sensors include wireless transmission capability.

9. The system of claim 1, further including a monitoring station coupled to the sensors by wiring.

10. The system of claim 8, further including a monitoring station coupled to the sensors by a wireless network.

11. The system of claim 1, wherein the pressure sensors are mechanical cantilevers.

12. The system of claim 11, further including one or more optical laser scanning heads, and a monitoring station coupled to the scanning heads.

13. The system of claim 1, wherein the pressure sensors contain memory for storing permanent data and for storing pressure readings.

14. The system of claim 13, wherein the memory is flash-based.

15. The system of claim 14, wherein the memory is magnetic flash memory.

16. The system of claim 15, farther including a magnetic reader for accessing and erasing the magnetic flash memory.

17. A method for recording pressure variations across a representative or actual surface of a substrate under vacuum comprising the acts:
(a) staging a substrate having multiple MEMS pressure sensors fixed thereto in the vessel subject to vacuum;
(b) connecting the substrate to an external monitoring station;
(c) pumping down the vessel;
(d) activating the sensors;
(e) recording the multiple pressure readings; and
(f) calculating the pressure variations from the multiple readings.

18. The method of claim 17, wherein in act (a) the substrate is a dummy test wafer.

19. The method of claim 17, wherein in act (a) the substrate is an actual workpiece wafer.

20. The method of claim 17, wherein in act (b) the connection is a wired connection.

21. The method of claim 17, wherein in act (b) the connection is a wireless connection.

22. The method of claim 17, wherein in act (d) the sensors are powered from outside the vessel by wire.

23. The method of claim 17, wherein in act (d) the sensors are powered from a battery cell mounted on the substrate.

24. The method of claim 17, wherein in act (b), monitoring is performed externally to the process system using pressure values stored in local memory and thus the complete pressure history from loading to exit from the tool can be recorded.

25. The system of claim 1, wherein sensors for detecting temperature or gas species, or combination of those are included on or near the pressure sensors.

26. The system of claim 25, wherein readings from the temperature sensors or gas sensors of from a combination of those are used as variables for calculating local flow rates or gas concentrations.
